(19) United States
(12) Patent Application Publication
(10) Pub. No.: US 2006/0290986 A1
(43) Pub. Date: Dec. 28, 2006

(54) Method and apparatus for processing and dividing images into finished prints

(76) Inventor: K. Clive Liu, Los Altos, CA (US)

Correspondence Address: K. Clive Liu, 25426 Adobe Lane, Los Altos, CA, 94022, US

(21) Appl. No.: 11/477,336

(22) Filed: Jun. 28, 2006

Related U.S. Application Data
(60) Provisional application No. 60/696,671, filed on Jun. 28, 2005.

(51) Int. Cl. G06K 15/00; G06F 15/00

(52) U.S. Cl. 358/1.18; 358/1.9; 358/1.12

(57) ABSTRACT

The invention provides a method and apparatus for processing and setting individual image as one or more image pages; combining, transferring and dividing image pages into the final finished individual photos or cards. The present invention allows images to be selected and quantities of each image needed to be defined by a user. All images selected, including the number of copies of each image required, are processed to fit the required print size with over print areas on all sides of each image. Images are set up as one or more pages in an order. Adjacent images of a row in each image page are combined with required gap and centered to the page. Combined images are transferred to output by lines or in bands. Prints are divided into final individual photos or cards by separating the image from boarder, over-print, and gap areas. The present invention enables a fully integrated system that is small and flexible to be used anywhere; and the system cost is low and efficient for producing a full-bleed and 100% clean edge photos or cards.

This application claims priority under 35 USC 119(e) of co-pending provisional application No. 60/696,671 filed Jun. 28, 2005 entitled A Method and Apparatus for Generating And Dividing Images into Photos And Cards, hereby incorporated by reference in its entirety.

### BACKGROUND OF THE INVENTION

1. Field of the Invention

This invention relates to the method of processing and setting individual image as one or more image pages; combining and transferring adjacent images for printing and dividing the print into the final finished individual prints such as photos or cards. This invention also relates to an apparatus of processing and dividing images into final finished individual prints, with a storage, an input and display, a processor, an output, plurality of non-moving circular knifes and a moving circular knife.

2. Background

The rapid growth of digital camera sales and advances in digital printing technology has generated an increasing demand to process and print photos digitally. Based on the chemical-based system for developing films and processing photos, all photo conglomerates such as Kodak, FujiFilm, Konica etc. have produced some hybrid mini-lab systems that are capable of developing films, processing photos and printing images (digital photos). All these hybrid mini-lab systems used roll-feed paper with separate paper magazines in various widths (5″, 6″, 8″ etc.) to image each photo of the same size onto the roll paper of desired width/length, and cut each photo from the roll paper sequentially.

Inkjet printing has recently become one much lower-cost and environmental-safe printing technology which can produce photos digitally with quality and durance similar to the traditional chemical-based photo processing. Inkjet printer companies such as HP, Epson and Canon all improved their printing technology so the ink can cover the entire page; a technique known as “sedge-to-edge” printing, to produce full-size photos whether they are 3×5, 4×6, 5×7 or 8×10. All these printer conglomerates have developed and shipped a small printer used by anyone as a personal photo lab, to produce the most common photo size-4×6 photos by printing images on the individual paper which has been pre-cut and trimmed to the final finished photo size, before printing.

Noritsu Koki Co. Ltd. in Japan developed a strategic alliance with Epson by incorporating the “edge-to-edge” inkjet printing technology and produced a dry mini-lab system called Noritsu dDP-411. This system inherited the mini-lab system structure which used roll-feed paper with separate paper width magazines (5, 6, or 8 inch etc.) to receive images sequentially, print each photo of the same size onto the roll paper, and divide them into individual photos one by one. The system can produce 400 3R (3.5×5) or 310 4R (4×6) photos per hour, and make enlargements up to 12×18.

The prior art of digital photo processing by mini-lab systems offered higher production rate in producing photos. However, the system used roll-feed paper mechanism with separate paper magazines for various photo width/length, hence, the system is bulkier and the user needs to keep various inventories of different rolls of paper in various sizes and magazines. Another major problem with the mini-lab system is its high system cost, compared to the extremely low-cost inkjet printers that can produce equally good or better photos.

When the productivity of a digital photo processing system does not need to produce more than a hundred photos per hour, printers used to produce photos by printing on the individual sheet paper offers a much economical solution. However, the prior art of digital photo processing by printers offered printing images on the individual paper which has been pre-cut and trimmed to the finished photo size, to avoid the process of cutting and trimming the final finished photos after printing. This requires users to keep different size printers for printing different size photos; or users need to purchase different size of paper for different size photo printing. The recent personal digital photo lab systems are designed strictly for the most popular 4×6 photo size processed by inkjet printers. Obviously, the cost of these printers is low for processing 4×6 digital photos. However, it will require larger printers and different sizes of paper to produce other photo sizes. Another major problem with these personal digital photo lab systems is it can only produce no more than 10 photos per hour and is only for personal usage casually.

The prior art of image processing method takes each image, process, print them sequentially onto the roll-paper, or each image is printed on the pre-cut final photo-size paper individually. The method does not require the steps of combining one or more images onto a page for later printing. Some image processing methods used by software products known as Adobe® Photoshop Album, Microsoft® Picture It or Microsoft® Office Picture Manager combine one or more images onto a page for later printing. A major problem with these image processing methods is it requires users to individually divide each image printed on the paper as finished photo by cutting and trimming manually, so it is slow, error prone, and dangerous. Another major problem with these image processing methods is that there is no standard and efficient method used by existing software for setting up the image page and hence processing them.

It would be advantageous to provide a method and apparatus for processing and setting up individual images, combining and transferring adjacent images for printing and dividing into final finished photos or cards. The apparatus of the dividing device and its structure for cutting each page/sheet of paper will produce finished photos or cards with minimum or no paper waist. The system incorporated this invention will be small enough to put on the desktop or in an office environment as an in-house digital photo lab system. The system is easy to operate such that individual images can be combined, processed to become pages, printed onto sheet of paper, then divided into final finished sizes of photos and cards. The system costs are extremely low; compared to both chemical and non-chemical digital mini lab system. More, the system could produce individual photos and cards at the same or better speed compared to the dry mini-lab systems from Noritz or Kodak.

### SUMMARY OF THE INVENTION

The invention provides a method of processing, setting and combining individual images as image pages or sheets, transferring images to a page or sheet of paper and dividing them into individual finished prints such as photos or cards. This invention also provides an apparatus of a processing and dividing image device and its structure for dividing each page or sheet of paper into finished prints. The prior art of digital photo processing using mini-lab systems has been that each image is printed individually and sequentially on one or more roll-feed paper that a specific roll is used for the photo prints with the specific width (or length).

The mini-lab system then cut each individual image to its required length (or width) to finish the digital photo processing. The mini-lab system used roll-feed paper mechanism with separate paper magazines for various photo width/length (5, 6, or 8 inches). The prior art of digital photo processing by printers offered printing images on the individual photo-size paper (3.5×5, 4×6, 5×7 etc.), so the printer can image the entire paper without leaving the white boarders on the photo. Each sheet of paper used has been pre-cut and trimmed to the finished photo size to avoid the step of cutting. Users also use some image processing software such as Adobe® Photoshop Album, Microsoft® Picture It or Microsoft® Office Picture Manager to combine a few images for printing on the standard size paper (US Letter or A4). The prior art of processing and combining individual images for printing, as used by these image processing software, has been to start placing the 1^{st} image from the top-left corner of a page-size sheet paper; the 2^{nd} image to the right (X direction) or down (Y direction) of the paper until the maximum number of images can fit on one sheet of paper. Images are printed to the exact photo size required, but images are placed not to the center of the paper on both directions, resulting un-even boarders and various dimensions of the gap between images. Users either keep the images on the paper as an album page, or need to divide each image as final individual photos manually.

The present invention requires each image to be processed slightly larger than the required final photo size. For example, processing each image containing 1 mini-meter over-print on each side of the photo, so a 4×6 inch (101.6×152.4 mm) photo requires printing an image of 103.6×154.4 mm in size. Images placed on the page follow a particular order, not by the simple left-right, top-down placement used by the prior art, so image page or image sheet are further divided and collated in a desired order by the apparatus invented hereunder. Adjacent images of a row are centered to the page with equal amount of left-right border areas and required gap between adjacent images. Adjacent images are transferred for output line-by-line or in bands for output with the equal amount of top-bottom borders and required gap between adjacent images.

Another aspect of the invention provides the apparatus of the processing and dividing device and its structure for processing, setting and combining individual images as image pages or sheets, transferring images to a page or sheet of paper and dividing them into individual finished prints such as photos or cards. The invention integrates the printing and cutting functions in one structure that allows dividing images at the same time transferring adjacent images for output. The invention integrates cutting and shredding functions in another structure that allows dividing images by separating and shredding the over-print, gap and boarder areas. The apparatus of processing and dividing images reduced the efforts in producing the accurate-size photos and cards from separate piece of paper in page-size, or roll paper in different sizes.

The present invention changes how the images are processed and divided into finished photos, and cards. The prior art of image processing method takes each image, processes, prints and divides them sequentially using the roll-paper, as used by the digital mini-lab systems. Or each image is printed on the pre-cut final finished photo-size paper individually, as used by the personal lab system (inkjet printer). The prior art of image processing using a standard-page-size paper by some popular image processing software, combines individual images onto image pages for printing by a simple top-down, left-right direction. The result requires users to individually divide each image printed on the paper as finished photo by cutting and trimming manually, so it is slow, error prone, and dangerous; or users just keeping the images on the paper. The present invention provides a method and apparatus for processing and setting individual image as one or more image pages; combining and transferring adjacent images for printing and dividing the print into the final finished individual prints such as photos or cards. The result is a low-cost, easy, safe, and error-free and an efficient system for digital photo processing and color cards reproduction.

The foregoing and many other aspects of the present invention will no doubt become obvious to those of ordinary skill in the art after read the following detailed description of the preferred embodiments that are illustrated in the various drawing figures.

### DESCRIPTION OF THE DRAWINGS

FIG. 1 illustrates a conceptual overview of a preferred embodiment of the invention, for the method of processing and dividing images into final finished individual print;

FIG. 2 illustrates a conceptual overview of a preferred embodiment of the invention, for the method of processing and dividing double-side images into final finished individual print;

FIG. 3 illustrates a structure overview of a preferred embodiment of the invention, for the method of processing and dividing images into final finished individual print using page-size paper or a roll-feed paper;

FIG. 4 illustrates a high level schematic showing the setting of each individual image, including the copies of the images for the quantities required onto one or more pages, pursuant to the method of the present invention:

FIG. 5 illustrates a high level schematic showing the processing and transferring images of each page, including the copies of each image for the quantity required, onto a page pursuant to the method of the present invention;

FIG. 6 illustrates a high level schematic showing the division and separation of the final prints from the boarder, gap and over-print areas of the image page or image sheet, and producing individual prints of correct size pursuant to the method of the present invention:

FIG. 7 illustrates a structure overview showing the process of an integrated output and divide apparatus of processing the image to fit its desired print size and including over-print areas; setting up the image and its copies needed as one or more image pages; combining and transferring adjacent images of a row to print; dividing the print to produce the final finished individual print, pursuant to the method of the present invention:

### DESCRIPTION OF THE PREFERRED EMBODIMENTS

Detailed Description

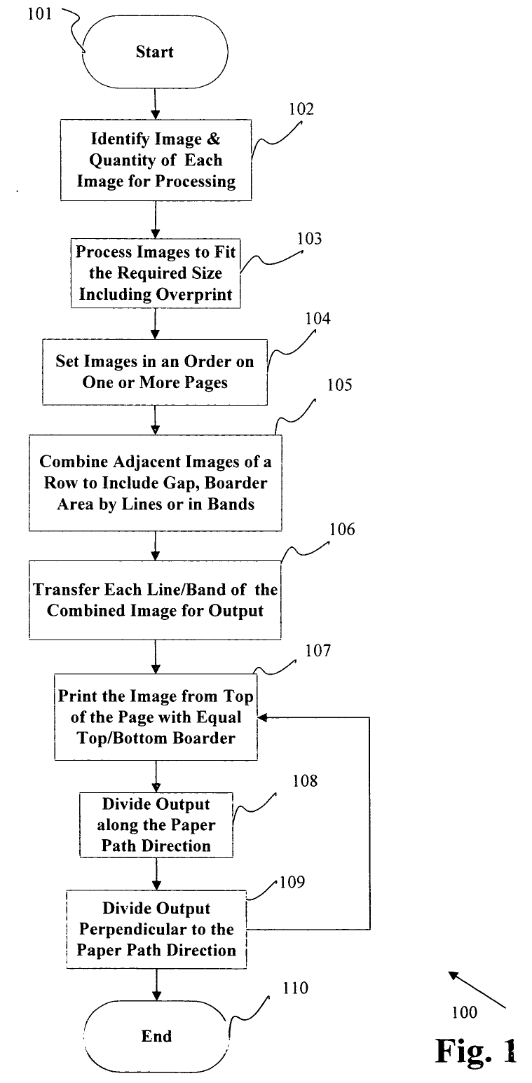

FIG. 1 illustrates a conceptual overview of a preferred embodiment of the invention, indicated by general reference character 100, for the method of processing and dividing images into final finished individual print. The process 100 initiates at a “start” terminal 101 after images are made available for processing. At the step 102, identifies images and quantity of each image to be processed. At the step 103, images are processed to fit the required print size (e.g. 3×5, 4×6, 5×7 etc.) and to include overprint areas on all four sides of the image. Each overprint area is one or more units (for example 1 mm). At the step 104, processed images are set up in an order on one or more pages so that all prints will be collected as one or more stacks in the desired order. At the step 105, adjacent images of a row (X-direction) are combined to include the necessary boarder, gap areas by lines or in bands and leave the equal amount of Left and Right boarder space. At the step 106, combined images of a page are transferred by lines or in bands for output. At the step 107, output starts at the top of the page leaving the equal amount of Top and Bottom boarder space. Step 108 divides the output along the paper path (Y-direction). Step 109 divides the output perpendicular to the paper path (X-direction) and continues at the step 107 108 to produce the final finished individual print. The process 100 completes through an “end” terminal 110.

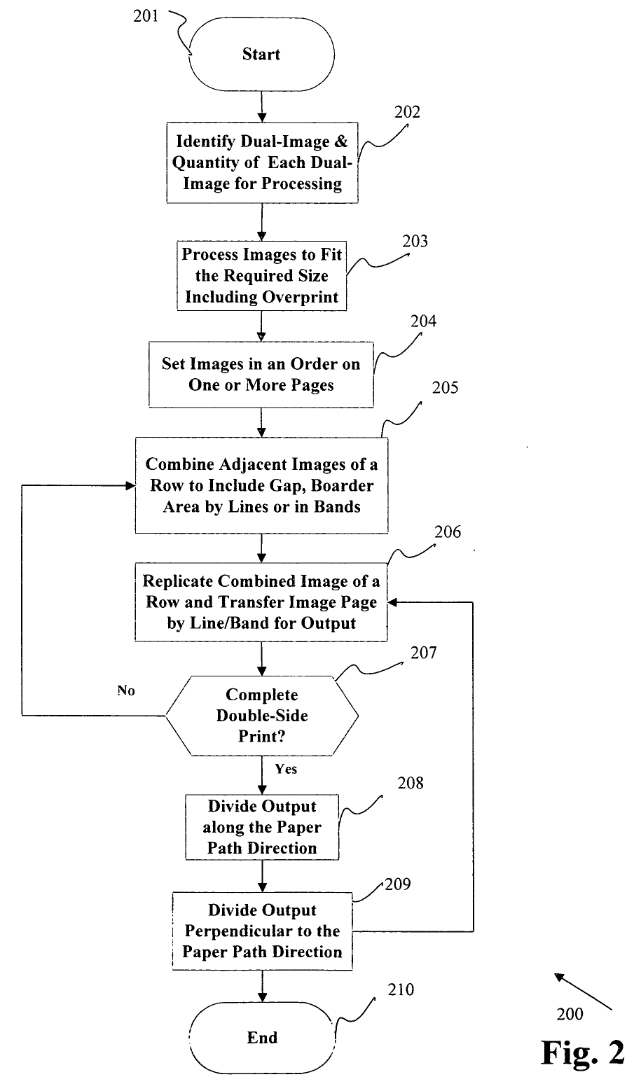

FIG. 2 illustrates a conceptual overview of a preferred embodiment of the invention, indicated by general reference character 200, for the method of processing and dividing double-side images into final finished individual print. The process 200 initiates at a “start” terminal 201 after images are made available for processing. At the step 202, identifies dual (front-back) images and quantity of each dual-image to be processed. At the step 203, images are processed to fit the required print size (e.g. 51 mm×89 mm, 55 mm×90 mm, 4×6, 5×7 etc.) and to include overprint areas on all four sides of the image. Each overprint area is one or more units (for example 1 mm). At the step 204, processed images are set up in an order on one or more pages so that all prints will be collected as one or more stacks in the desired order. At the step 205, adjacent images of a row (X-direction) are combined to include the necessary boarder, gap areas by lines or in bands and leave the equal amount of Left and Right boarder space. Step 206 replicates the combined images of the row, adding gap between them, for the image page to be transferred by lines or in bands for output. Output starts at the top of the page leaving the equal amount of Top and Bottom boarder space. A “Double-Side” decision step 207 repeats at step 205, to complete the output of a double-side print. Step 208 divides the output along the paper path (Y-direction). Step 209 divides the output perpendicular to the paper path (X-direction) and continues at the step 207 208 to replicate the remaining image pages and produce the final finished individual print. The process 200 completes through an “end” terminal 210.

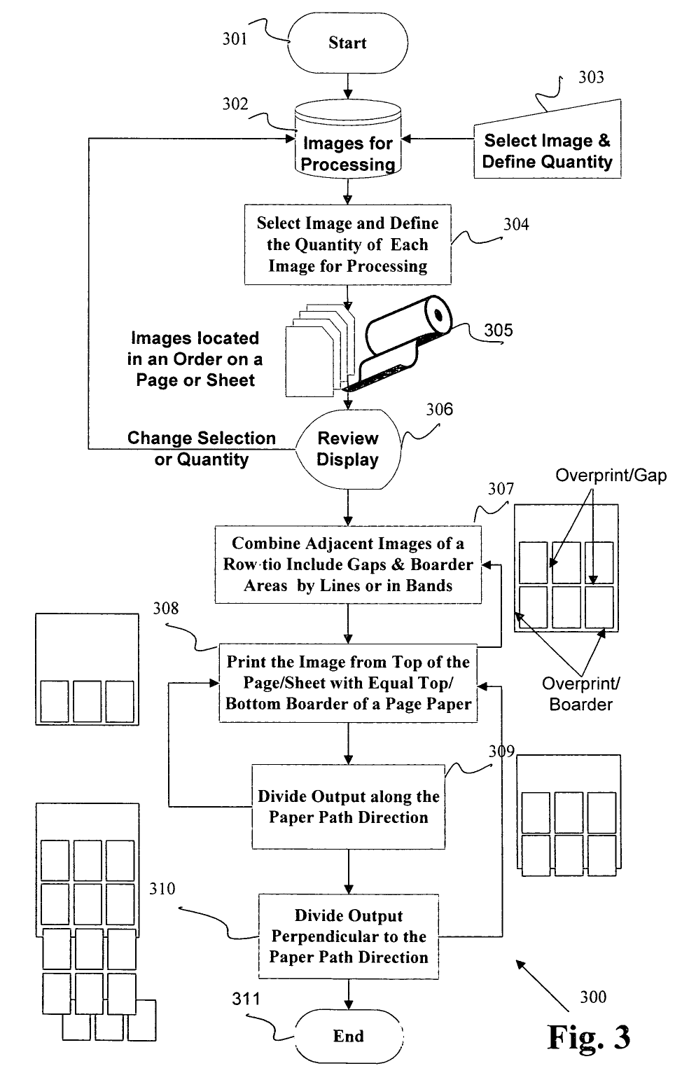

FIG. 3 illustrates a structure overview of a preferred embodiment of the invention, indicated by general reference character 300, for the method of processing and dividing images into final finished individual print using page-size paper or a roll-feed paper. The process 300 initiates at a “start” terminal 301 after images are made available for processing and located at the storage 302. Through the step 303, user selects images and defines the quantity of each image for processing at the step 304. At the step 305, images are processed to fit the required print size and to include overprint areas on all four sides of the image. At the step 306, processed images are set in an order on one or more image pages or image sheets displayed for review. The step repeats at the steps 302 303 304 and 305, if user needs to change the selection or the quantity value for the selection of the images for processing. At the step 307, adjacent images of a row (X-direction) are combined to include the necessary boarder, gap areas by lines or in bands and leave the equal amount of Left and Right boarder space. Combined images of a page or sheet are transferred by lines or in bands for output. At the step 308, output starts at the top of the page leaving the equal amount of Top and Bottom boarder space of a page paper. Step 309 divides the output along the paper path (Y-direction).

Step 310 divides the output perpendicular to the paper path (X-direction) and continues at the step 308 309 to produce the final finished individual print. The process 300 completes through an “end” terminal 311.

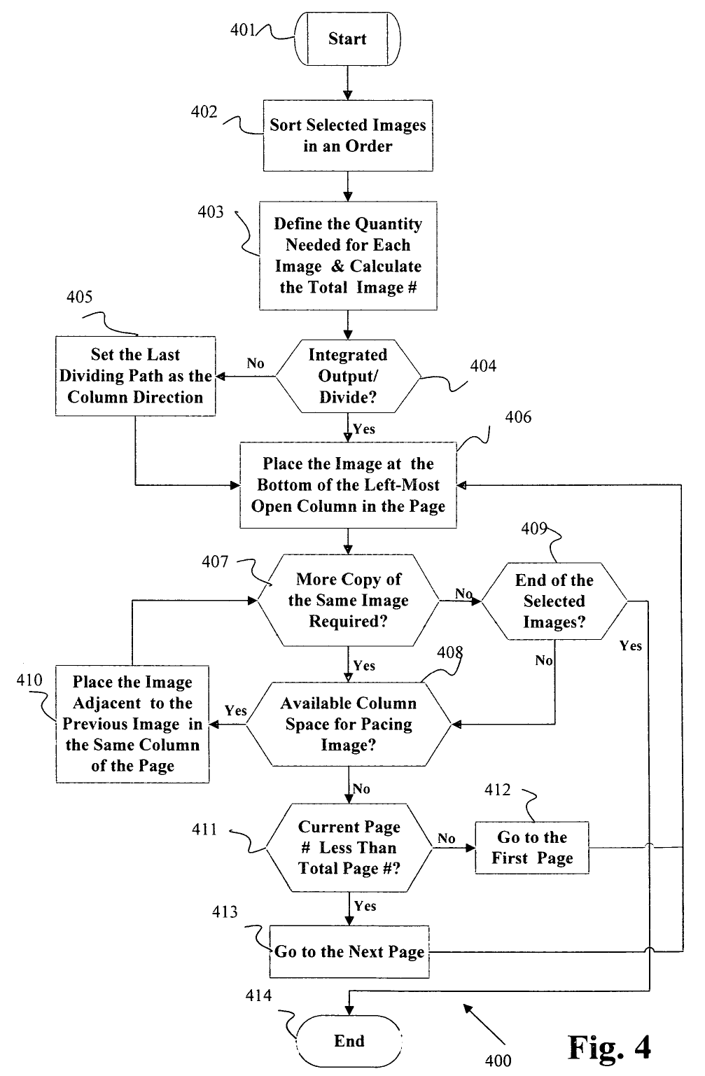

FIG. 4 illustrates a high level schematic showing the setting of each individual image, including the copies of the images for the quantities required onto one or more pages, pursuant to the method of the present invention; indicated by general reference character 400.

The process 400 initiates at a “start” terminal 401 after the user has selected images for processing. At the step 402, images selected are sorted in an order such as by the time stamp of the image file. At the step 403, user defines the quantities of each selected image needed and the total number of the images required for processing and output is calculated. At the “Integrated Output/Divide” decision step 404, the process determines the paper path direction (Y-Column or X-Row) for placing each image. The process takes the paper path direction as the “Y-Column” direction and place the image at the bottom of the left-most column that is open for placing the image in the page at the step 406. Images on the page are printed up-side-down; therefore, the image at the bottom of the column will be divided in the last of the column. At the step 405, a non-integrated, X-Y one-pass dividing process sets the last dividing direction as the “Y”, in which the row (paper width) direction could becomes the Y (column direction) for placing each image. The process continues at step 406 to place the image at the bottom of the left-most column that is open for placing the image in the page. If the “More Copy” decision step 407 requires more copies of the same image for placement, the process continues at “Column Space Available” decision step 408 to check where to place the image. If the column space is available for placing the image, then at the step 410, the image is placed at the location adjacent to the previous image in the same column of the page. The process repeats at the “More Copy” decision step 407, if no more copy of the same image required for placement, the process continues at “End of Image” decision step 409 to continue the process at “Column Space Available” decision step 408 to see where to place the remaining images, if more images required for placement. If at the step 408, the column space is not available for image placement, the process checks the whether the current image page is the last image page for placing images at the “Current Page” decision step 411. The process continues at the step 412 to place the image in the first page, if the current page is the last page for placing images. Otherwise, the process continues at the step 413 to place the image in the next page, if the current page is not the last page for placing images. Both steps of 412 and 413 repeat at the step 406 to place the image at the bottom of the left-most column which is adjacent to the previous column, until the “End of Image” decision step 409 has no more image or its copies for placement. The process 400 completes through an “end” terminal 414

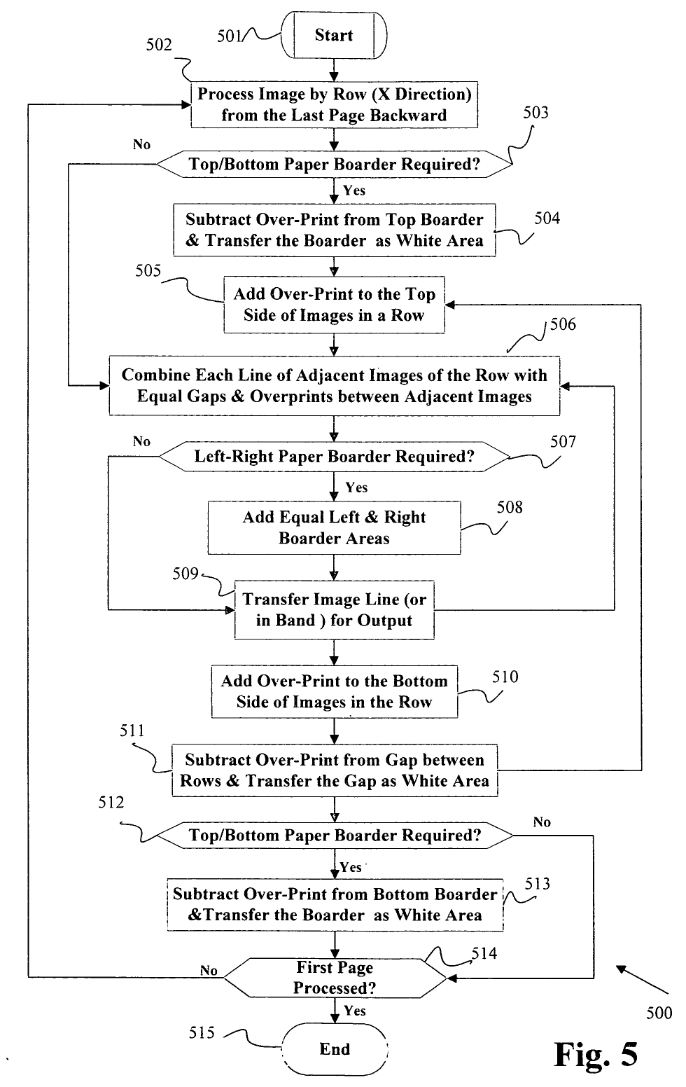

FIG. 5 illustrates a high level schematic showing the processing and transferring images of each page, including the copies of each image for the quantity required, onto a page pursuant to the method of the present invention; indicated by general reference character 500. The process 500 initiates at a “start” terminal 501 after all images, including the copies of each image for the quantity required, are set up as one or more image pages. At the step 502, the process starts the processing from the top row of the images in the last image page. A “Top/Bottom Boarder” decision step 503 enables the process to start combining adjacent images of the row at the step 506, if no top/bottom paper boarder is necessary since the image can be output to the edge of the paper. Otherwise, at the step 504, the process subtracts over-print size from the top boarder size and transfers the remaining boarder size as white area (no image pixel information). The process continues at the step 505 and adds the over-print to the top side of the images in the same row. At the step 506, the process combines each line of adjacent images of the same row by adding over-print to the right of the left image line, gap, and over-print to the left of the right image line of the adjacent image. The over-print and gap between adjacent images are all equal in size. A “Left/Right Boarder” decision step 507 enables the process to add equal left and right boarder to the image line to complete the process of each line at the step 508. If no left/right paper boarder is necessary, at the step 509, the process transfers the combined image page by lines or in bands to produce the image sheet. The processed image lines or bands are transferred to the sheet resulting the gaps between images are symmetrical to the center lines in both X and Y axes. The process repeats at steps 506 507 508 and 509 until one image row is transferred. At the step 510 the process adds the over-print to the bottom side of the images in the row. At the step 511 the process subtracts over-prints from the gap area between the rows above and below and transfers the remaining gap size as white area. A “Top/Bottom Boarder” decision step 512 enables the process to complete the processing of the current image page, if no top/bottom paper boarder is necessary. Or, the process continues at the step 513 to subtract over-print size from the bottom boarder size and transfer the remaining boarder size as white area. A “First Pager” decision step 514 repeats the process at step 502 for the next page until the first page of the images are processed and transferred to the sheet. The process 500 completes through an “end” terminal 515

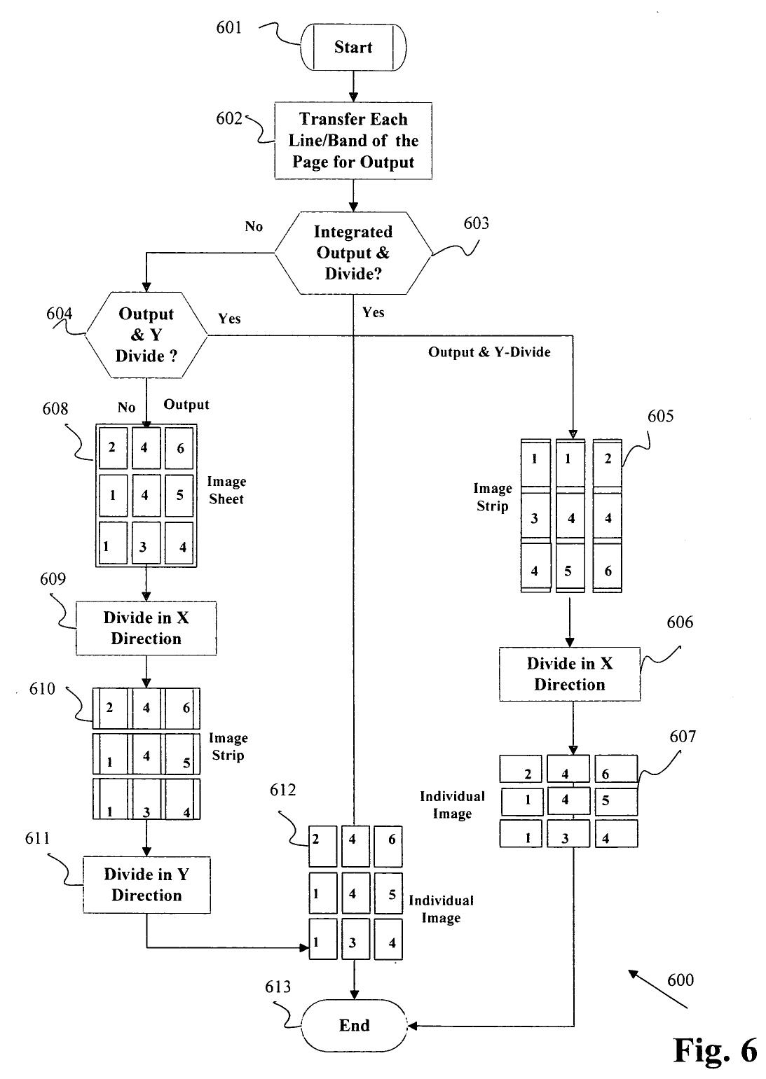

FIG. 6 illustrates a high level schematic showing the division and separation of the final prints from the boarder, gap and over-print areas of the image page or image sheet, and producing individual prints of correct size pursuant to the method of the present invention indicated by general reference character 600. The process 600 initiates at a “start” terminal 601 after all images, including the copies of each image for the quantity required, are setup as one or more image pages. At the step 602, the process starts the transferring adjacent images by lines or in bands to produce an image sheet. An “Integrated Output & Divide” decision step 603 enables the process to produce individual prints of correct size at the step 612. Or, the process continues at “Output & Y Divide” decision step 604 to transfer the image page to a page or sheet and divide the image page or sheet into image strips along the Y (Column) direction as in the step 605. The process continues at the step 606 to divide the image strips along the X (Row) direction and produce individual prints of correct size at the step 607. At “Output & Y Divide” decision step 604, if the output and divide along the Y (Column) direction is not integrated, the process continues to produce the image sheet at the step 608. At the step 609, the process divides t he page sheet into image strips as the step 610. The process continues at the step 611 to divide the image strips along the X (Row) direction and produce individual prints of correct size at the step 612. The process 600 completes through an “end” terminal 613.

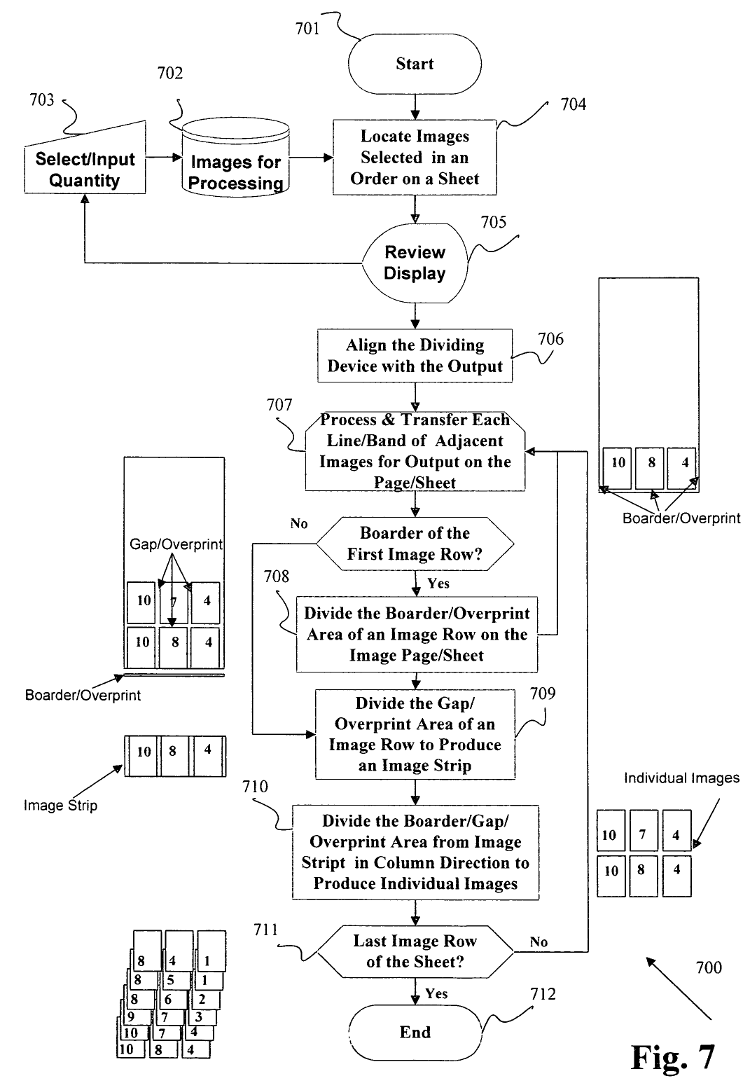

FIG. 7 illustrates a structure overview showing the process of an integrated output and divide apparatus of processing the image to fit its desired print size and including over-print areas; setting up the image and its copies needed as one or more image pages; combining and transferring adjacent images of a row to print; dividing the print to produce the final finished individual print, pursuant to the method of the present invention in accordance with the preferred embodiment, indicated by general reference character 700. The process 700 initiates at a “start” terminal 701 after images are made available for processing and located at the storage 702. Through the step 703, user selects images and defines the quantity of each image for processing. At the step 704, images are processed to fit the required print size and to include overprint areas on all four sides of the image. At the step 705, processed images are set in an order on one or more image pages or image sheets displayed for review. At the step 706, the process begins processing and transferring images from top row in a page upside down, according to the page/sheet moving direction used in the output device. At the step 707, the process begins dividing the image page/sheet along the paper path, while the process continues transferring adjacent images of a row for output the page/sheet. At the step 708, when the image page/sheet reaching a registered mark, the process initializes a moving circular knife traveling perpendicular to the paper path for removing the boarder/overprint area of an image row. At the step 709, the process divides the boarder, over-print and gap areas in row direction. The process repeats at the step 707 and continues dividing the image page/sheet in along the paper path direction; pauses to separate the boarder, over-print and gap areas for the images in the next row until the images of the page/sheet are completely transferred and divided at the step 710. At the step 711, the process repeats at the step 706 to process and transfer images of the next page/sheet, if more image pages/sheets are available for processing. When all pages/sheets are transferred and divided, the process 700 completes through an “end” terminal 712.

One skilled in the art will understand that the invention provides a flexible and efficient method and apparatus for the processing, setting, combining, transferring and dividing images into final finished-size of photos and prints.

From the foregoing, it will be appreciated that the invention has (without limitation) the following advantages:
1) For a photo lab or image service facility, the invention provides a valuable, low-cost, productive and environment-friendly system for photo processing and printing services, as compared to the current chemical-based photo processing systems used in the industry;
2) For in-house digital photo printing, the invention allows small inkjet printers used at home or office to become a most cost-effective system to produce one or more photos from a standard page-size (Letter/A4) or a custom-size photo paper;
3) For in-house digital color reproduction, the invention provides an efficient, low-cost, chemical-free system for photo cards, business cards, name cards, ID cards and post cards printing production. Retail businesses and small/medium size companies can produce these cards within the same day compared to many days or weeks turn-around time if printed by an offset printing press or a commercial printer;
4) Home and business users can use standard page-size or custom-size paper for the printing to save the print cost and minimize the paper waist. Instead to “snap” each card apart from the sheet, users can use the automatic cutter to divide individual print apart from the sheet to produce each photo or card with all the image printed to the edge and 100% clean edges after cut;
5) A fully integrated system that is small and flexible to be used anywhere such as in convenience stores for photo processing and card re-production. The desktop unit contains a micro processor and storage to receive images and instructions from user through a small LCD display; performs the processing, setting, combining, transferring to output and dividing and other functions, all in this environmental friendly system.

While the invention has been herein shown and described in what is presently conceived to be the most practical and preferred embodiment thereof, it will be apparent to those of ordinary skill in the art that many modifications may be made thereof which scope is to be accorded the broadest interpretation of the appended claims so as to encompass all equivalent methods and processes.

Although the present invention has been described in terms of the presently preferred embodiments, various modifications and alterations can be made without departing from the scope of the invention. Accordingly, the scope of the invention is not to be limited to the particular invention embodiments discussed herein, but should be defined only by the appended claims and their equivalents.

What is claimed is:

1. A method of generating and dividing images into final finished individual prints; comprising the steps of:
(a) Defining images and the quantity of the individual image to be processed;
(b) Processing images to fit its desired print size and include over-print areas;
(c) Setting up images in an order as one or more image pages;
(d) Combining adjacent images of a row to include the boarder, gap areas;
(e) Transferring adjacent images of a row to print and divide.

2. A method of claim 1, further including defining only one image; processing the image to fit its desired print size and including over-print areas; setting up the image and its copies needed as one or more image pages; combining and transferring adjacent images of a row to print; dividing the print to produce the final finished individual print.

3. A method of claim 1 (b), further including processing images with automatic adjustments tools such as brightness, contrast, color balance etc. and other adjustments such as red-eye removal etc. in generating higher quality images.

4. A method of claim 1 (c), further including setting up images in an order as one or more image sheets, then combining/transferring adjacent images of a row to print on a roll paper, dividing the print to produce the final finished individual print.

5. A method of claim 1 (c), further including setting up one or more additional images to include individual images as thumbnails.

6. A method of claim 1 (c), further including setting up images in an order that the prints will be collected as one or more stacks of prints in the desired order.

7. A method of claim 1 (d), further including combining the adjacent images by lines or in bands; centering the adjacent images of a row on the page with equal amount of boarder areas.

8. A method of claim 1 (b) (d), further including processing images with 1 mm or more overprint areas for each side of the image; and combining adjacent images of a row to include 1 mm or more gap; and centering adjacent images of a row on page with equal amount of border areas.

9. A method of claim 1 (e), further including transferring the adjacent images to print by lines, in bands, by row or by page; dividing the print when printing is in progress or completely done.

10. A method of generating and dividing dual-images into final finished individual prints with front and back sides; comprising the steps of:
(a) Defining dual images for the front and back sides and the quantity of prints needed;
(b) Processing images to fit its desired print size and include over-print areas;
(c) Setting up images in an order as one or more image pages;
(d) Combining adjacent images of a row, on one side of the image page to include the boarder, gap areas;
(e) Transferring adjacent images of a row to complete printing on one side, repeat at step (d) for combining, transferring adjacent images of a row to print the other side and then divide the print.

11. A method of claim 10 (b), further including defining multiple dual-images for one or multiple copies; processing images to fit its desired print size and including over-print areas; setting up, combining, transferring adjacent images to print on both sides for one or multiple copies; dividing the print to produce the final finished individual print.

12. A method of claim 10 (e), further including transferring adjacent images for printing on both sides simultaneously, and then dividing the print to produce the final finished individual print.

13. A method of claim 10, further including processing variable text and replaceable images to produce the image pages on both sides of the print;

14. A method of claim 10, 11, further including setting up images in an order as one image sheet, and then transferring adjacent images to print on the roll paper.

15. An apparatus of generating and dividing images into final finished individual prints, comprising:
(a) A storage for keeping images for processing;
(b) An input and display for selecting images, defining the quantity of each image print needed, and previewing;
(c) A processor for processing, setting up images, including their duplicates, as one or more image pages; combining adjacent images and transferring the image page for output;
(d) An output for printing image page, starting from the top of the image page to the bottom of the page, from one image page to the last page;
(e) A plurality of non-moving circular knifes, rotating along axes, for dividing the printed area along the paper moving direction by separating the boarder, over-print and gap areas from the print.
(f) A moving circular knife, traveling along its axis, for dividing the printed area perpendicular to the paper moving direction; by separating the boarder, over-print and gap areas from the print to produce the final finished individual print.

16. An apparatus of claim 15, further including a separate computer comprising storage, input and display, processor; a separate printer/cutter or a separate cutter comprising a plurality of circular knifes for dividing prints on both directions.

17. An apparatus of claim 15 (c) (d), further including setting up images in an order as one or more image sheets; combining, transferring adjacent images to a printer with one or more rolls of paper.

18. An apparatus of claim 15 (e), further including one set of non-moving circular knifes, rotating along its axis, and one set of re-locatable, and detachable circular knifes for dividing prints.

19. An apparatus of claim 15 (f) further including the moving circular knifes with double-blades for dividing prints.

20. An apparatus of claim 15 further including placing registered marks on image pages or image sheets for the paper alignment and for the moving circular knife in dividing images as finished prints.
